(19) United States
(12) Patent Application Publication
(10) Pub. No.: US 2011/0277643 A1
(43) Pub. Date: Nov. 17, 2011

(54) Quick heating quartz toaster

(76) Inventors: Roger Schwierking, Cheyenne, WY (US); Douglas L. Hornbeck, Cheyenne, WY (US)

(21) Appl. No.: 13/068,334

(22) Filed: May 9, 2011

Related U.S. Application Data
(60) Provisional application No. 61/395,257, filed on May 11, 2010.

(51) Int. Cl. A47J 37/08; H05B 1/02

(52) U.S. Cl. 99/331; 99/391

(57) ABSTRACT

A commercial toaster apparatus having a “quick start” feature that nearly instantly changes from a “standby” mode to a “toasting” mode. The “quick start” mode is provided by changing the circuitry of some of the quartz heating elements from a series configuration to a parallel one wherein a higher voltage can be applied for a controlled amount of time to regulate the quartz heaters without adversely affecting the life span of the heating elements. Temperature probes are used to adjust the duty cycle of the apparatus to enable a uniform toast color as the cavity chamber temperature of the toaster changes over time. A sensor is also provided that determines when a last product is placed on the conveyer and the duty cycle has been completed so that the unit will automatically switch to a “standby” mode, thus reducing the energy requirements of the toaster.

This application claims benefit of U.S. Provisional Application Ser. No. 61/395,257 filed May 11, 2010 pursuant to 35 USC §119(e).

### FIELD OF THE INVENTION

This invention relates to a toasting apparatus, in particular, a method and apparatus for quickly heating the quartz elements in a toasting apparatus.

### BACKGROUND OF THE INVENTION

The method of scorching bread to preserve it dates back to the Romans. Additionally, toasting makes the bread crunchier and thus provides an ideal surface for spreading all sorts of things. In fact, the word “toast” comes from the Latin terms torrere, tostum—meaning to scorch or burn. The tradition spread to Britain and the English colonists brought the tradition to America.

Electric toaster appliances date back at least to the early 1900's. The earliest electric toaster was invented by Charles Strite in 1919. The first units utilized an open resistive wire arrangement that upon having a current placed in the wire caused the wire to heat and glow. The untoasted slice of bread was placed in the unit adjacent to the heating element and left there for a period of time until the toast was properly browned. Since the toast frequently ended up ‘black’ due to forgetting to remove it in a timely manner, a timer was added and pop-up features were also added to remove the toast when done.

To provide for large quantities of toast products to be produced quickly, commercial toasters were developed that made use of a conveyor belt sandwiched between heating elements that typically use quartz-heating elements to provide the heat. In this manner, slices of bread or other products that are to be toasted are fed into the feed port in the top front of the appliance and a conveyor slowly passes the slices of bread between the heating elements. By controlling the length of time the slices of bread are exposed to the heating elements by controlling the speed and length of the conveyor and by controlling the temperature of heating elements, the toast can be uniformly done.

Once the slice of bread reaches the end of the conveyor, it is dropped into an exit below. For continuous operation, the unit can be designed to have an adjustable baffle that changes the direction of the exit from the bottom front of the unit to the rear.

Representative of this type of apparatus is APW Wyott's model XTRM-2. This device uses a radiant heat system with a convection pre-heat system to pre-dry the bread (or product to be toasted) in the loading zone. The unit is said to produce 800 slices of toast per hour.

While this device works well, it is does have some drawbacks. These units are typically heated with quartz heaters that heat up to infrared. Therefore, these heaters are able to provide a good heat transfer system. In order to ensure that the time spent toasting the product is uniform; the unit must be in the “standby” mode to allow the heating elements to reach proper toasting temperature before the slices of bread are presented to the conveyor. While the use of a “standby” position does reduce the energy requirements substantially, a problem is encountered when the unit must be switched from “standby” to “toasting” mode. If the heaters are heated up rapidly using present methods, the life of quartz heaters are substantially reduced. On the other hand, if the quartz heaters are allowed to heat more slowly to reach operating temperatures, too much energy is used. Further, this will substantially delay the time before toasting can properly occur.

A toaster that has a “ready” mode that can be quickly heated to a toasting temperature without substantially shortening the life of the quartz heating elements is not found in the prior art.

### SUMMARY OF THE INVENTION

It is an aspect of the invention to provide a commercial toaster apparatus that has a quick start feature that nearly instantaneously changes the “stand-by” mode to “toasting” mode.

It is another aspect of the invention to provide a commercial toaster apparatus that has heating elements using open coils.

It is still another aspect of the invention to provide a commercial toaster apparatus that has heating elements that are made from quartz.

Still another aspect of the invention is to provide a commercial toaster apparatus that substitutes ribbon heating elements similar to those used in glass top ranges that have a longer life than similar quartz heaters.

Another aspect of the invention is to provide a commercial toaster apparatus that features a conveyor to move the product to be toasted in the apparatus.

Another aspect of the invention is to provide a commercial toaster apparatus that uses a sensor that determines that when the last product was placed on the conveyor and has completed its cycle, the unit will automatically change to the “stand-by” mode thus reducing the energy requirements of the toaster.

Still another aspect of the invention is to provide a commercial toaster apparatus that has exterior surfaces cool-to-the-touch during toasting operations.

Another aspect of the invention is to provide a commercial toaster apparatus that has a “stand-by” mode wherein heating elements are cycled such that less current is running through the heating elements when in this mode to conserve energy.

Still another aspect of the invention is to provide a commercial toaster apparatus that saves energy yet is able to achieve a quick start feature by applying a higher voltage for a shorter period of time to heat the quartz heating elements from a “stand-by” mode to “heating” mode and applies a lower voltage during the toasting operation.

Another aspect of the invention is to provide a commercial toaster apparatus that uses temperature probes to adjust the duty cycle of the apparatus to enable a uniform toast color as the cavity temperature in the toaster changes over time.

Still another aspect of the invention is to provide a commercial toaster apparatus that has a user selectable switch for toast, bagels or muffins.

Another aspect of the invention is to provide a commercial toaster apparatus that has a plurality of user defined power levels in memory.

Finally, it is an aspect of the invention to provide a commercial toaster apparatus that switches the quartz heaters' connections between parallel and series configurations wherein a higher voltage can be applied for a controlled amount of time to quickly heat the quartz heaters without adversely affecting the life of the heaters.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is an isometric view of the toaster apparatus in accordance with the invention.

FIG. 2 is an isometric view of the toaster apparatus shown in FIG. 1 with the top and right side panels removed to show the four top quartz heating elements.

FIG. 3 is a schematic view of the four top quartz-heating elements shown connected in the parallel configuration for high voltage quick heating operation.

FIG. 4 is a schematic view of the quartz heating elements shown in FIG. 3, now connected in a serial configuration for toasting operation wherein the wattage for each quartz heater is now half of what it was in FIG. 3.

FIG. 5 is a schematic view of the quartz heating elements shown in FIG. 3 now in the “stand-by” mode or energy saving configuration wherein the circuit is rectified to provide approximately ¼ of the maximum power that was provided in the quick heating mode.

FIG. 6 is a flow chart of process steps in accordance with the invention without using a sensor to determine when the last product was placed on the conveyor and has completed its cycle.

FIG. 7 is a flow chart of the process steps in accordance with the invention using a sensor to determine when the last product was placed on the conveyor and has completed its cycle.

FIG. 8 is a flow chart of the process steps in accordance with the invention in an alternative embodiment using ribbon heaters.

FIG. 9 is an isometric view of an alternative embodiment of the toaster apparatus.

FIG. 10 is an isometric view of the alternative embodiment of toaster apparatus shown in FIG. 1 with the top and right side panels removed to show the four top quartz heating elements and the two temperature probes.

### DETAILED DESCRIPTION OF THE INVENTION

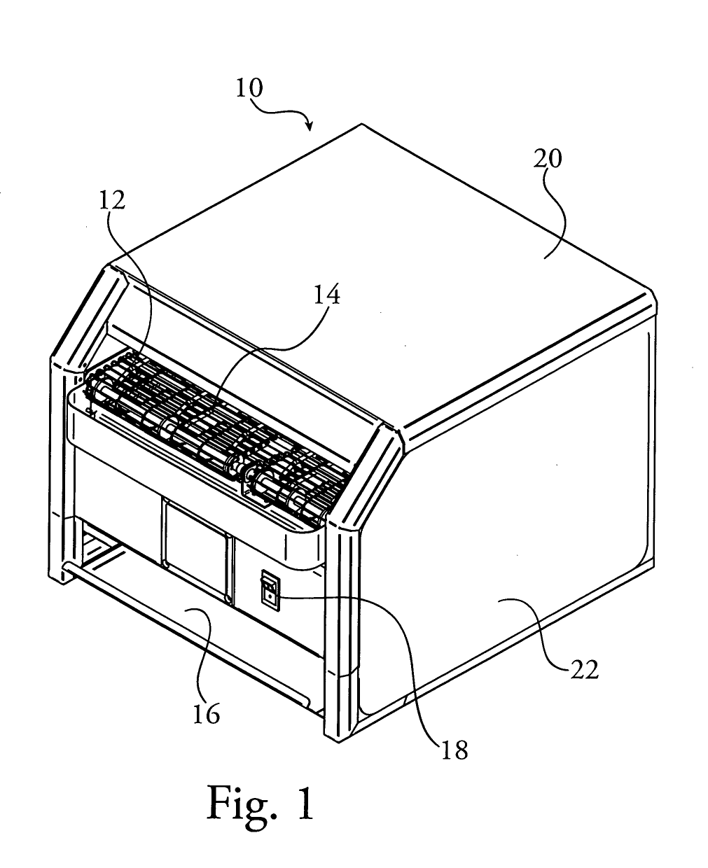

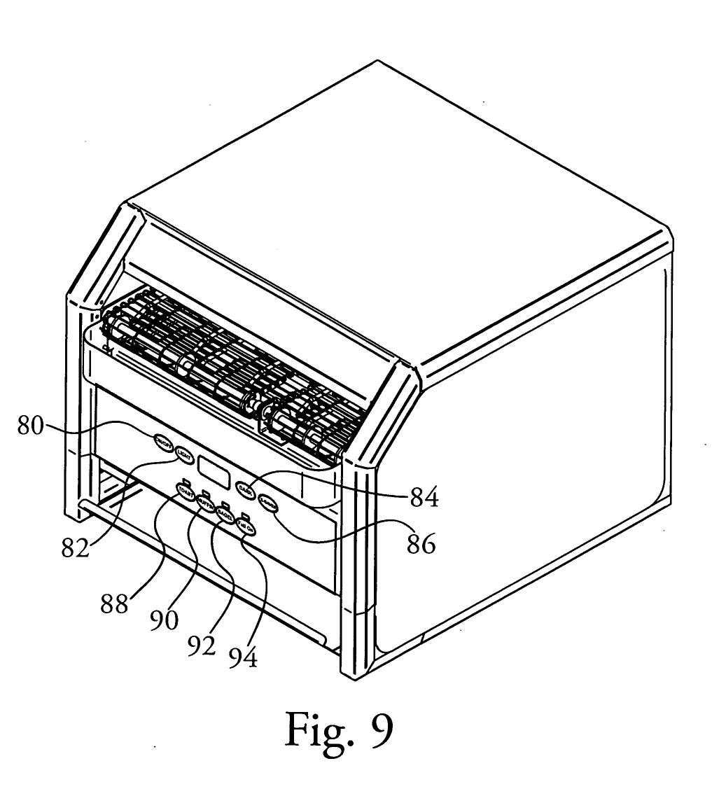

As shown in FIG. 1, toaster apparatus 10 has a similar appearance to most commercial conveying toaster apparatus. The product is placed in opening 12 onto conveyor 14, which moves the product (usually bread slices) between top and bottom heating elements at a predetermined rate such that the product will be properly toasted when it reaches the end of conveyor 14. The product then drops from conveyor 14 to be available to a user via opening 16. Switch 18 enables the user to turn the unit either on or off. Other controls (see FIG. 9) might include devices to control the speed of conveyor 14 to permit adjustment of the degree of toasting as well as indicator lights to tell when the unit is on/off or at a particular temperature such as heating, operating, stand-by, warming, etc.

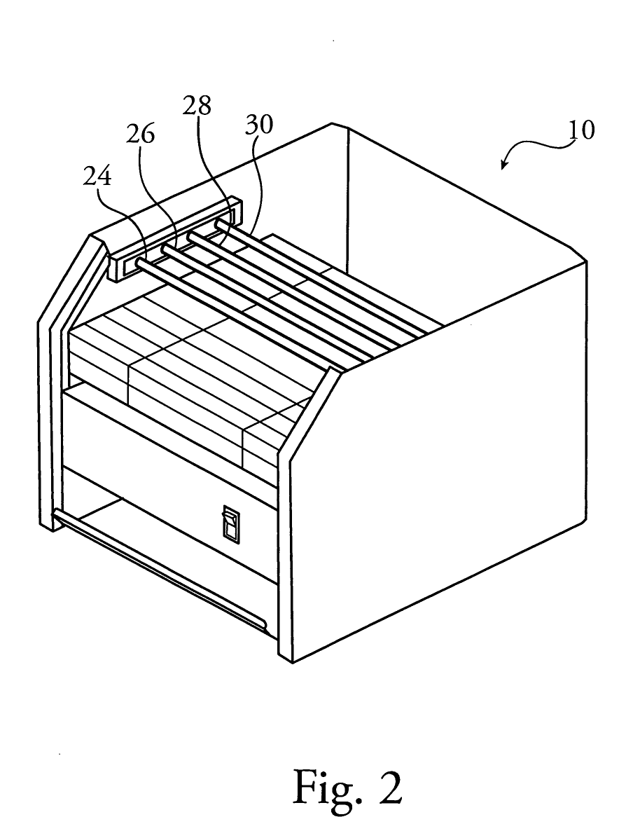

As shown in FIG. 2, panels 20 and 22 have been removed from toasting apparatus 10 to show top quartz heaters 24, 26, 28, and 30. Identical bottom quartz heaters (not shown) are position below conveyor 14 so that the product that is being toasted will be toasted on both sides at once without the need for placing the product through a second time to toast the side not toasted by top quartz heaters 24 through 30.

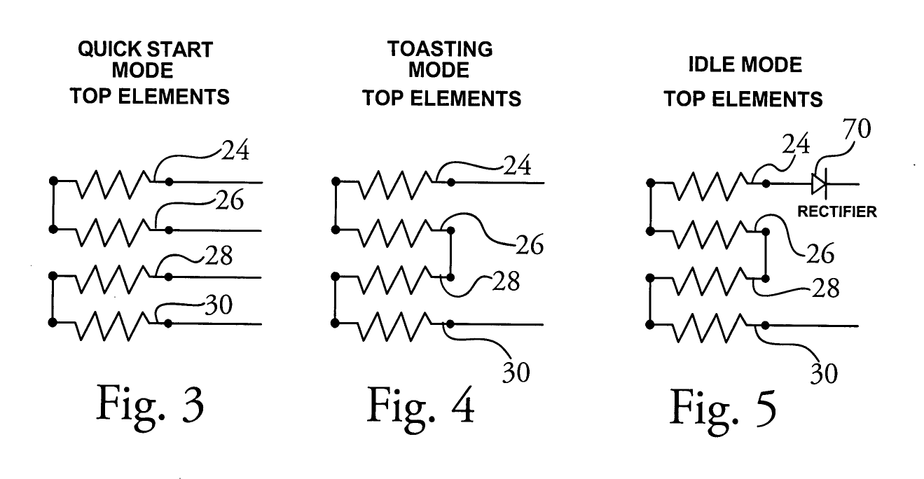

Referring now to FIG. 3, the schematic of top quartz heaters is shown in the “quick start” mode of operation. Note that the bottom quartz heaters (not shown) would be identical. Prior art design quartz heaters are configured to run at only one voltage. To heat up quickly, prior art methods increase the watt density (watts per square inch of quartz heater surface). However, this will substantially shorten the life of the quartz heater. However, if the watt density is lowered, the heaters take too long to heat up and the unit does not toast properly.

Heater 24 is temporarily connected as if heater 24 was in parallel position to heater 26. Likewise, heaters 28 and 30 are connected the same. Correspondingly, bottom heaters (not shown) would be configured similarly. Since the four heaters (24, 26, 28, 30) are in series at the supply voltage (there would be models using supply voltages of 208, 240 and 110 respectively), upon switching the configuration to two elements in series, the voltage is doubled and the wattage is increased by a factor of 4. This switching occurs only briefly, preferably only a matter of 1 and ½ seconds or thereabouts. This permits the quartz heaters to heat quickly as the watt density is permitted to be four times the original wattages. For example, for a 2800 watt 208 volt unit, the wattage would be 11,200 watts for 1.4 seconds. In this brief amount of time, a good toasting temperature can be reached but this length of time is not long enough to shorten the life of the heaters.

After the quartz heaters are heated, the unit is switched as shown in FIG. 4; that is, quartz heaters 24 through 30 are connected in series. In this configuration, quartz heaters 24 through 30 are run at ½ the maximum wattage. That is, 208 volt units would be rated at 2800 watts and 110 volt units would be rated at 1725 watts. This configuration is similar to prior art devices where the heating elements last longer but require too much time for the heating elements to reach toasting temperature. However, in this case, the quartz heaters are already at a predetermined temperature due to the quick “heating” mode that had just occurred prior to switching to this mode. Therefore, the extra time that would be required for the heating elements using this configuration are unnecessary due to the use of the quick heating configuration.

The schematic in FIG. 5 shows the invention in the “stand-by” mode that causes the unit to be run using approximately ¼ of the power used in maximum wattage mode. By keeping the quartz heaters at a “stand-by” condition using rectifier 70, the heaters are not permitted to go through the thermal shock of heating and completely cooling and then re-heating again. Thus, the heaters last longer. Further, by running at ¼ power, the toaster apparatus will use less energy and thus save the user energy costs. Present toasters with quartz heating elements maintain body cavity temperature by turning the heating elements on or off. This method of maintaining a desired toaster cavity temperature is extremely hard on the quartz heating elements and consequently reduces their life expectancy.

The switching and timing to change from the configurations shown in FIGS. 3-5 is accomplished using a digital controller and mechanical or solid state relays, which are all well known in the art.

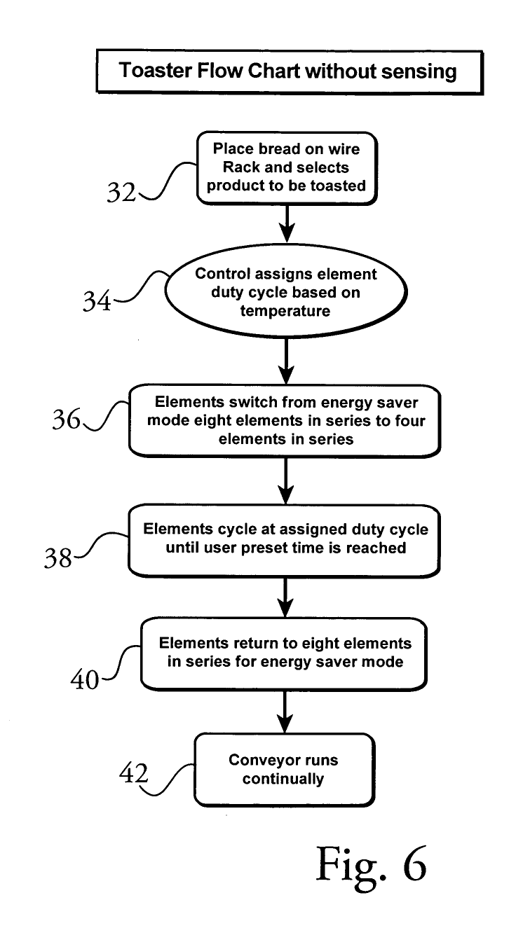

Referring to FIG. 6 shows a flow chart of the process steps provided by digital controller (not shown) and relay (also not shown) in the embodiment without the use of a sensor. In step 32, an operator places the product to be toasted on conveyor 14 and selects product type. In step 34, the digital controller assigns the element duty cycle based on the temperature of the heating elements. In step 36, the heating elements cycle at an assigned duty cycle until the operator preset time is reached. After the pre-set time is reached, in step 40, the heating elements are switched into the series for the energy saving mode or idle mode. Step 42 has the conveyor 14 running continually.

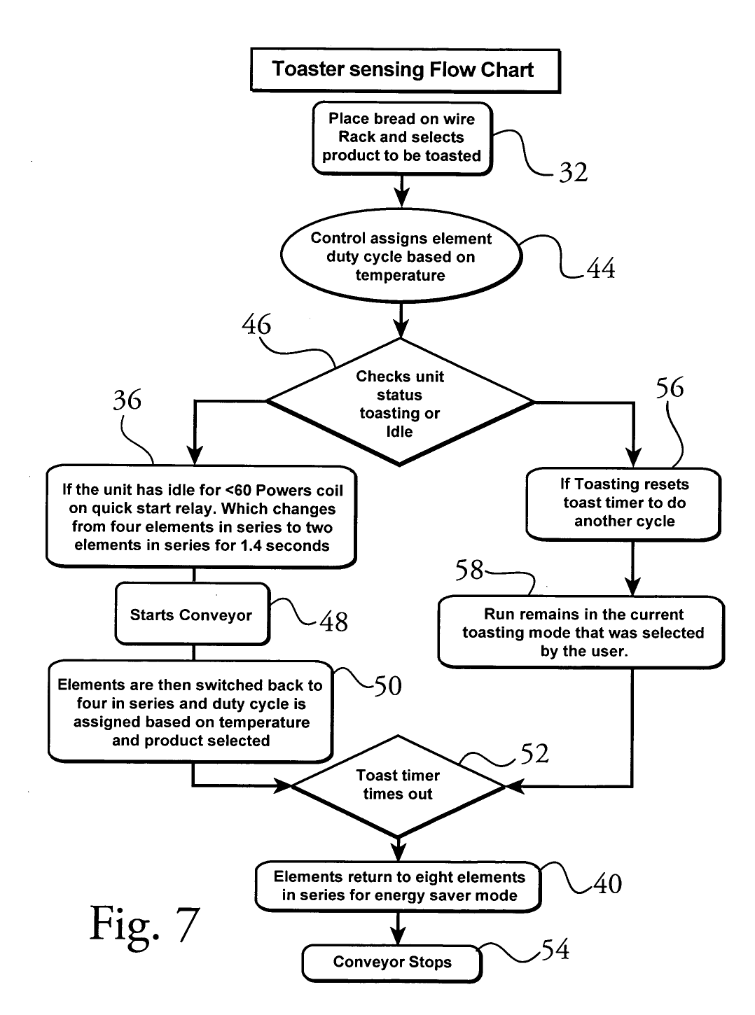

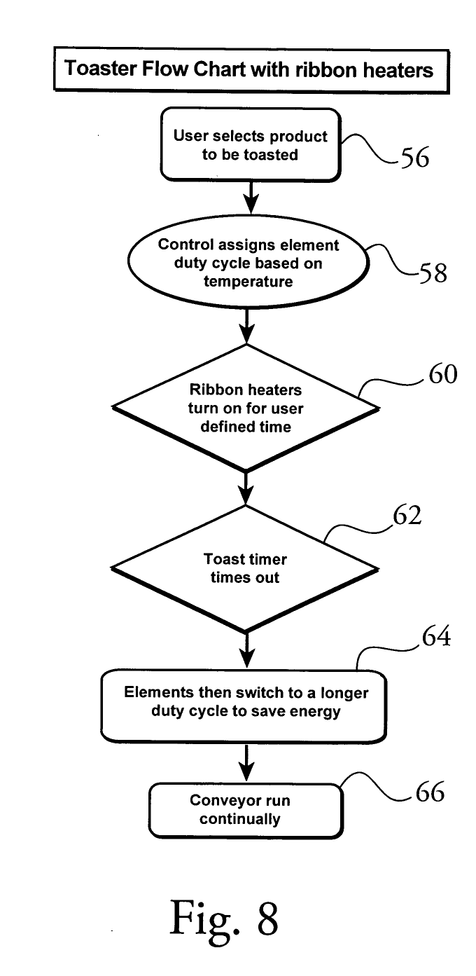

In FIG. 7, the preferred embodiment shows the process steps necessary when using a sensor (not shown). The sensor is a typical “capacitance touch” type that is well known in the art. This capability would be part of the digital control board. The sensor would be located on the wire rack where the product is placed for toasting. Step 32 is as previously discussed in the non-sensor embodiment. Once a product is placed on wire rack; the sensor senses a change in capacitance thereby providing a signal to the controller indicated by step 44. In step 46, the controller checks to see whether the unit is in idle or is toasting. If the unit is in the toasting mode at the time, then in step 56, the unit is reset to do another toasting cycle followed by step 58 where the unit remains in the current toasting mode that was previously set by the operator.

If the unit is in “idle” mode at the time, the path starting with step 36 is followed. Step 36 is similar to the step shown in FIG. 6. Only in this case, if the unit is been in the “idle” mode for more than 60 seconds, the quick start relay is activated by the digital controller wherein the unit changes the circuitry configuration from the top and bottom four heating elements connected in series to the top and bottom heating elements connected to two heating elements in series as shown in FIGS. 5, 3 respectively.

Step 48 starts conveyor 14. Once conveyor 14 is started, step 50 causes heating elements 24-30 to be changed to the toasting mode as shown in FIG. 4. Further, the duty cycle is assigned based on the temperature and product previously selected by the operator.

Once the cycle is completed, step 52 causes the unit to “time out”. In step 40, also shown in FIG. 6, the heating elements 24-30 then switch back again to the top and bottom four heating elements being connected in series. Finally, in step 54, conveyor 14 is stopped.

If it is desired to use ribbon heating elements instead of the quartz heaters, then the flow chart shown in FIG. 8 is utilized. With the use of ribbon heaters (well known in the art), the quick start relay would not be needed. In this case, in step 56, an operator selects the product to be toasted. Then, in step 58, the digital controller assigns the heating element duty cycle based on the pre-selected temperature. In step 60, the ribbon heaters are then turned on based on the operator's selection. From there, in step 62, the unit times out when the pre-selected time is reached. In step 64, the unit is switched to a substantially longer duty cycle to save energy. Finally, in step 66, conveyor 14 is set to run continually as in step 42 shown in FIG. 6.

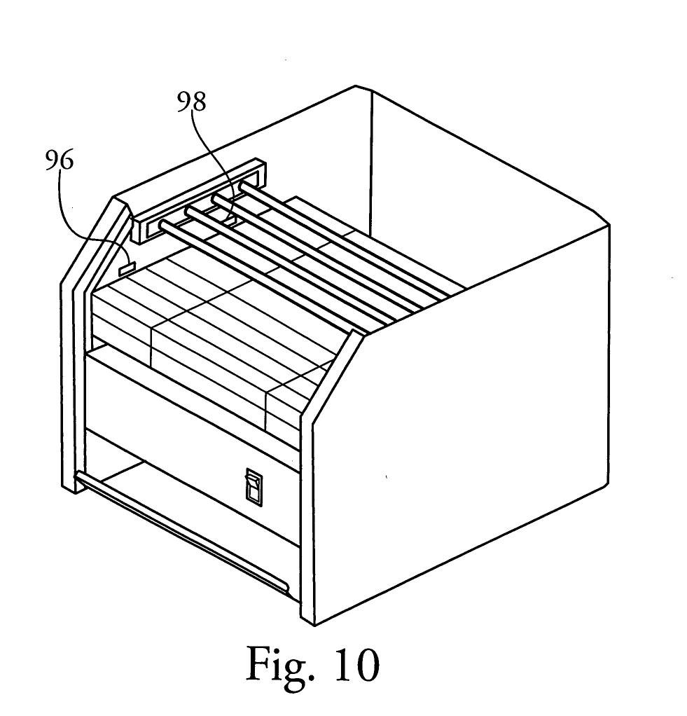

Referring now to FIGS. 9 and 10, an alternative embodiment of the toaster apparatus 10 is shown. This embodiment enables the toaster to provide the same toast color as the cavity temperature in the toaster changes with use or lack of use.

When the toaster is in the idle mode, the cavity temperature is monitored by temperature probe 98. If the cavity temperature measured is decreasing over time, this is designated as a “fall” and if the cavity temperature measured is increasing over time, this is designated as a “rise”.

On/off switch 80 is comparable to switch 18 shown on FIG. 1. For lighter toasting, button 82 is selected. For darker toast, button 84 is pushed. These buttons correspond to pre-set power level settings, 1 through 5. If a user level is set on power level, for example, a user pushing the “dark” button 84 will cause the unit to shift to power level 4. If the user presses the “light” button 82, the power level will shift to 2. If the apparatus has already been set at 5, the power level will not go up. However, the power level can go down to 4 if the “light” button 82 is pressed. Also, at no time will be power level lower to off even if the power level is set at 1 and then the “light” button 82 is pressed.

If a user wants to place the unit in “stand-by” mode, button 86 is pushed for energy saving operation. Depending on the product that is to be toasted, button 88 for toast, button 90 for muffins, button 92 for bagels can be selected. Button 94 over-rides the automatic toast color feature if desired.

The automatic toast color feature operates as follows. First, the toasting characteristics of a particular toaster are measured by setting the cavity at the lowest likely cavity temperature that the unit should see during toasting. This temperature is designated as the “base cavity temperature”.

For example, with the preferred model of the toaster disclosed herein, that temperature measured at probe 98 is 300 degrees. Both probe 98 and probe 96 are preferably resistant temperature detectors or RTD's.

Next, the time that product takes to travel from the front of conveyor 14 to the back where the product drops down the chute is determined and designated as “tested base time”. In this case, the time is 65 seconds. This value could be changed depending on belt speed, length of the conveyor and so on. Also, different units will have differing base temperature measurements and test base times but the process can be scaled easily to accommodate different toaster characteristics.

The energy requirements to obtain a desired predetermined color were measured and designated as “base joules”. In this case, the value obtained was 33.65 joules.

Then the test was run again with the cavity temperature increased as measured by probe 98. The conveyor speed was kept at 65 seconds. Once the toast color was the same as the prior test, the energy requirements for that condition were measured. This test was again repeated several times at differing cavity temperatures and the data obtained yielded an empirically derived formula. This formula showed the amount of energy needed at different cavity temperatures to keep relatively the same toast color. If the same toast color was to be obtained as a faster speed, the formula could be rearranged to keep the heating elements on all the time and increase the conveyor speed so that toast was exposed to the same amount of energy. If a darker degree of toasting was wanted, the base joules could be changed to a higher number.

The steps of this power level adjustment process are as follows:

1. Temperature from temperature probe 96 and temperature probe 98 is read into memory. Probe 96 is used to determine whether a product has been placed on conveyor 14. If the temperature measured by probe 98 is on the “rise”, then time for measurement is 20 seconds, if the temperature measured by probe 98 is on the “fall”, then time for measurement is 30 seconds.

2. The temperature reading on probe 98 is subtracted from the base cavity temperature. Recall that the base cavity temperature is obtained experimentally.

3. Then, the difference between the two is multiplied by the joules per degree. In this case, which is “on the fall”, that number is 0.09. Joules per degree is obtained as the difference in temperature form the current cavity temperature provided by probe 98 to the tested base cavity temperature determined by experiment as described above. In the case of a “fall”, that number is 0.09 and in the case of a “rise” that number is 0.12.

4. That result is then subtracted from the base joules value that was previously calculated. In this case, that number is 33.65.

5. That number yields joules required at temperature measured by probe 98. This number is divided by the joules per second. Joules per second is derived from the wattage of the toaster unit divided by the number of seconds in an hour or 3600.

6. This number reveals the total time that the heating elements “x” must be on during the 65 second traverse of the product on conveyor 14.

7. Finally, the result above is divided by duty cycle, which in this example is 65 seconds or the time that a product takes to traverse the conveyor 14.

For example, with an “on the fall” probe 98 of 15 degrees, that is obtained by the measurement at probe 98 and obtaining 315 degrees and then subtracting the base cavity temperature of 300 degrees.

The number 15 is multiplied by joules per degree, that is, 0.09.

The answer of 1.35 is subtracted from the base joules of 33.65.

This result of 32.3 is divided by joules per second of 0.777, which results in 41.53 joules. Finally, this result is divided by the base tested time of 65 seconds which yield of a duty cycle that will keep the heating elements on 63.8% of the time.

The apparatus is equipped to have a plurality of power levels, preferably five, as mentioned above, but more or less number of levels could be used depending on the range of color changes in the toasted product as well as the type of product that is being toasted.

In this alternative embodiment, the five levels of power are as follows. Level 1 corresponds to 30% less that the power calculated using the above process. Level 2 is 20% less. Level 3 is the calculated power level. Level 4 is 20% more and level 5 is 30% more than the calculated power.

As noted above, probe 96 is used to determine whether a product has been placed on conveyor 14. If the toast button 88 is pressed and if probe 96 indicates a “fall” of more than 2 degrees in the time frame measured, then the power level calculated by the above method will be increased by 40% due to the amount of product that has been placed on conveyor 14. If this level of “fall” isn't detected, the duty cycle will remain as calculated until the cycle time is complete.

If the bagel or muffin button is pressed, the apparatus always assumes that both halves of a bagel or muffin have been placed on the conveyor and, therefore, adjusts the apparatus accordingly.

Although the present invention has been described with reference to certain preferred embodiments thereof, other versions are readily apparent to those of ordinary skill in of the preferred embodiments contained herein.

What is claimed is:

1.) A quick heating toasting apparatus comprising:
a plurality of heating elements; wherein said plurality of heating elements are powered by a supply voltage; such that when a portion of said heating elements are connected in parallel, a “quick start” mode of operation is provided and wherein that portion of said heating elements are then connected in series, a “toasting mode of operation is provided;
controlling means for changing the configuration of circuitry of said plurality of heating elements from the “quick start” mode of operation to the “toasting” mode of operation and back again; wherein said controlling means further comprises:
timing means for setting a predetermined amount of time said apparatus is placed in the “quick start” mode such that said plurality of heating elements reach a desired toasting temperature.

2.) The quick heating toasting apparatus of claim 1 further comprising:
rectifier means connected to said plurality of heating elements for providing a “stand by” mode of operation to prevent said heating elements from going through the thermal shock of completely cooling and then being re-heated again wherein said rectifier means is controlled by said controlling means such that said “stand by” mode substantially reduces the amount of energy necessary to power the apparatus when in this mode.

3.) The quick heating toasting apparatus of claim 1 wherein the predetermined amount of time is approximately 1.4 seconds.

4.) The quick heating toasting apparatus of claim 2 further comprising:
a selectable duty cycle time provided by said controlling means which sets the amount of time that said apparatus is in the “toasting” mode before returning to the “stand by” mode;
sensor means connected to said controlling means for sensing whether a product has been placed in said apparatus to be toasted, if said apparatus is in the “toasting” mode, said controlling means initiates another duty cycle time to toast the product that has been sensed; if said apparatus is in the “stand by” mode for more than a predetermined amount of time, said controlling means initiates said “quick start” mode, than followed by said “toasting” mode; if said apparatus is in the “stand by” mode for less than the predetermined amount of time, said controlling means initiates the “toasting” mode with another duty cycle time.

5.) The quick heating toasting apparatus of claim 1 wherein said heating elements are quartz heaters.

6.) The quick heating toasting apparatus of claim 2 wherein the “stand by” mode provided by said rectifier means enables a body cavity temperature of said apparatus to be maintained using less power without needing the power to said heating elements to be turned “off” and “on”.

7.) A quick heating toasting apparatus comprising:
a plurality of ribbon heating elements;
controlling means for changing the configuration of circuitry of said plurality of ribbon heating elements from a “stand by” mode of operation to the “toasting” mode of operation and back again; wherein said controlling means further comprises:
first timing means for setting a predetermined first amount of time that said apparatus is placed in the “stand by” mode;
rectifier means connected to said plurality of heating elements for providing said “stand by” mode of operation to prevent said ribbon heating elements from going through the thermal shock of completely cooling and then being re-heated again wherein said rectifier means is controlled by said controlling means such that said “stand by” mode substantially reduces the amount of energy necessary to power the apparatus and maintain a body cavity temperature of said apparatus to be maintained;
second timing means for setting a predetermined second amount of time said apparatus is placed in the “toaster” mode wherein said plurality of heating elements reach a desired toasting temperature such that when said second amount of time elapses, said controlling means switches said apparatus back into said “stand by” mode.
